(19) United States
(12) Patent Application Publication
(10) Pub. No.: US 2012/0088217 A1
(43) Pub. Date: Apr. 12, 2012

(54) Client-server based system and method for test and homework management

(76) Inventor: Pierce Freeman, Novato, CA (US)

(21) Appl. No.: 12/925,058

(22) Filed: Oct. 12, 2010

(51) Int. Cl. G09B 7/00

(52) U.S. Cl. 434/350

(57) ABSTRACT

A system and method for computer-aided test and homework management in client-server architecture comprises server software for a teacher to create tests and homework, and client software for students to take tests and complete homework assignments. The teacher uses the server software to correct the set-answers and multiple choices automatically. For creative responses in a free-style text format, matching pre-defined key words in the response is used for auto-grading, but can be overridden manually by the teacher. Keywords in the response are highlighted to help the teacher in the grading process. The client software provides a secure way to take a test by displaying a black background behind the window to block possible cheating utensils. The client software is also operable to administer testing and homework offline, as it downloads and saves test questions and homework assignments in the client data repository, which allows students to review all the tests and homework assignments previously taken.

### TECHNICAL FIELD

The present invention relates to computer-aided education and, more particularly, to computer-aided test and homework management.

### BACKGROUND

In the field of computer-aided education, a number of computerized systems for test and homework management have been implemented to improve efficiency, reduce cost, and eliminate geographical barriers. Functionalities of such systems include creating electronic-based tests and homework assignments, grading completed tests and homework assignments automatically, as well as administering testing in a secured way. There are various web-based course and homework management systems provided by online education providers. Prior computerized testing and course management systems are disclosed in U.S. Pat. Nos. 6,162,060, 6,418,298, 6,431,875, 6,684,053, and 6,678,500, each of which is expressly incorporated herein by reference in its entirety.

An electronic-based test has many advantages, such as paperless and automatic grading, over traditional paper-based tests. One important requirement for conducting a computerized testing is to prevent students from accessing information from the network as well as information stored on their local devices. Therefore, it usually requires specially designed hardware or software for administering the testing process in a secured and closed environment. For example, the client devices used by students in a standard test such as GRE, MCAT, and LSAT, may require specially built hardware connecting to the server through a dedicated network. Even when general-purpose computers are used as client devices, the test program must run on a specially built operating system (OS), instead of a generic commercial OS, such as Microsoft Windows and Linux. As a result, switching between normal computing mode and test administration mode requires rebooting the client devices from different OSs. It is thus desirable to have a computerized test being conducted on a general-purpose computing device running with a generic OS while maintaining a high level of security.

Auto-grading is another important feature associated with computerized test and homework assignments. There are many existing auto-grading systems for grading set-questions and multiple choices automatically, such as questions used in standard tests like GRE, MCAT, and LSAT. For questions with creative or narrative answers, however, manual grading is still required, and challenge thus remains to develop a grading mechanism for grading creative or narrative responses due to the complex syntax and semantics of natural languages.

Other limitations exist in current web-based online education systems. For example, all web-based online education systems require continuous network connectivity between the server (e.g., a web application with a centralized database) and the client (e.g., a web browser for students). This imposes great constraints on the physical location where students can take their homework assignments. It is not possible for students to work on homework assignments in locations where the Internet is not accessible. Another limitation of web-based systems is that no history data is retained on the client devices. For example, a student cannot review old homework or a test he/she took previously. As personal computing devices such as laptops, hand-held devices and smart phones become increasingly popular for teachers and students, it is desirable to continue improving systems and methods in the field of computer-aided education.

### SUMMARY OF THE INVENTION

A server computer is a computer system that provides services across a network to private users inside a large organization or to public users on the internet. A client computer makes a service request to the server, which fulfills the service request. The present invention in computer-aided test and homework management utilizes client-server architecture to overcome limitations of prior arts described in the previous section.

It is an objective of the present invention to help teachers grade creative responses in an effective and efficient way. In a preferred embodiment, auto-grading for creative responses is achieved by searching pre-defined keywords in the creative responses. In another embodiment, all pre-defined keywords shown in a creative response are highlighted to allow a teacher to quickly identify whether the key points are presented in the response. Moreover, the auto-grading tool in the present invention enables the teacher to insert comments to students' creative responses in a context sensitive way. For the same purpose of circling and pointing on examination papers, the feature of inserting comments also indicates the location of the comments, so the students are aware of the context of the remarks when reviewing the corrected test or homework. Providing teachers the ability to annotate students' creative responses constructively helps the students to improve the efficiency of their learning process.

It is another objective of the present invention to conduct testing in a secured way using a general-purpose computing device running on a generic operating system (OS). To measure a student's true knowledge and skill in the subject matter, testing must be administered in a secured manner to guarantee fairness and integrity. For this reason, testing usually is conducted in a centralized and isolated location, such as a closed classroom. Furthermore, the devices used by the students must be highly secured to prevent accessing other information on the device or on the internet. To achieve such level of security, a client device used for testing could be a specially built hardware, such as a dummy terminal. When a general-purpose computing device is used as a client device, security is provided by having the testing administration program running on a specially built OS that does not provide other services. Hence, the client device, a general-purpose computing device, can boot either from a generic OS for normal computing use or from the special OS for conducting a test. One novelty of the present invention is to provide testing security while letting the testing program running on a generic OS with other applications. Therefore, to switch the client device from normal computing mode to testing administration mode, rebooting the client device with a specially built OS is no longer necessary. In one preferred embodiment, the security required by testing is achieved by displaying a full-screen black background behind the test window to block access to other programs and services during the entire testing process. The testing program according to the present invention cannot be stopped until the testing is completed.

It is a further object of the present invention to allow students to work on homework assignments without network connectivity. Unlike web-based online homework systems, which require connection to the server in order to be operable, the present invention allows downloading and storing the homework assignments in the data repository on the client device. As a result, homework assignments in the client device are available to be worked by students at any physical locations, and network access is not required.

It is yet an additional object of the present invention to provide a history of test and homework information for students to review at any time. In one preferred embodiment, the corrected tests or homework previously taken are stored in the data repository on the client device.

Other embodiments and advantages are described in the detailed description below. This summary does not purport to define the invention. The invention is defined by the claims.

### BRIEF DESCRIPTION OF THE DRAWINGS

FIG. 1A illustrates one embodiment of a client-server based homework and test management system in accordance with one novel aspect.

FIG. 1B illustrates the structure of a general-purpose computing device that is used as a server or client device in accordance with one novel aspect.

FIG. 2A shows the main modules on a server for test and homework creation and grading.

FIG. 2B shows the main modules on a client device for administering testing and homework as well as reviewing corrected tests and homework assignments taken previously.

FIG. 2C is a message sequence chart (MSC) which describes a flow of computerized test and homework management.

FIG. 3A is a flow chart for creating tests and homework assignments by a teacher using the computerized test and homework creation tool.

FIG. 3B shows a screen layout for creating tests and homework assignments.

FIG. 4A is a flow chart for grading tests and homework assignments by a teacher using the computerized grading tool.

FIG. 4B illustrates the screen layout for computer-aided test and homework grading.

FIG. 5 is a flow chart for allowing students to work on homework assignments on a client device, even when there is no network connectivity.

FIG. 6A is a flow chart for administering testing on a client device in a secured way.

FIG. 6B illustrates a method of blocking other programs on a client device, which is a general-purpose computing device, during a testing process.

### DETAILED DESCRIPTION

Reference will now be made in detail to embodiments of the present claimed subject matter, examples of which are illustrated in the accompanying drawings. While the claimed subject matter will be described in conjunction with these embodiments for illustration purposes, it will be understood that they are not intended to limit the claimed subject matter to these embodiments. On the contrary, the claimed subject matter is intended to cover alternatives, modifications and equivalents, which can be included within the spirit and scope of the claimed subject matter as defined by the appended claims. Furthermore, in the following detailed description of the present claimed subject matter, numerous specific details are set forth in order to provide a thorough understanding of the present claimed subject matter. However, it will be evident to one of ordinary skill in the art that the present claimed subject matter could be practiced without these specific details. Accordingly, various modifications, adaptations, and combinations of various features of the described embodiments can be practiced without departing from the scope of the invention as set forth in the claims.

In the present application, a test or a homework assignment consists of a plurality of questions, created by a teacher. A completed test or homework provided by a student consists of answers corresponding to the questions in the test or homework. A corrected test or homework consists of a plurality of scores and comments on answers. In general, there are three types of answers for test or homework questions. A first type of answer is a set-answer, which has a unique response to the corresponding question. For example, the solution for an arithmetic formula is a set-answer. Another type of answer is multiple choice of a question, which is completed by choosing one or more answers that are listed in the question itself. A third type of answers is creative response, or narrative response, which is in the format of free style text. Examples of questions that require creative or narrative answers include mathematical proof and essays. In the present application, the terms creative response and narrative response are used interchangeably. In addition, the term testing is used for the process of a student taking a test.

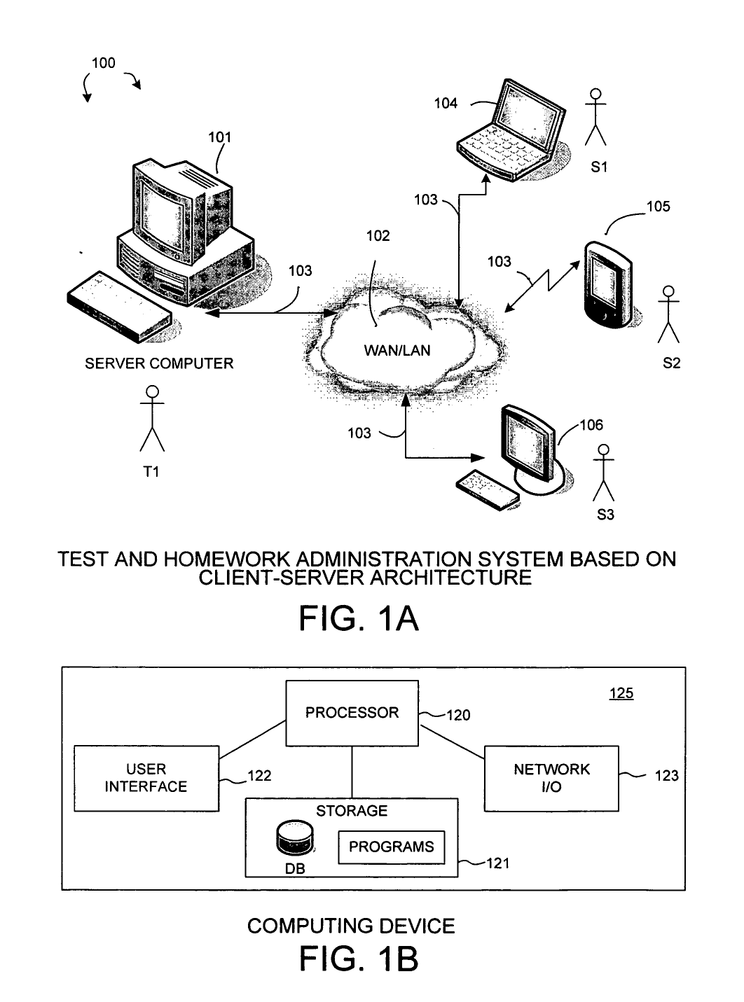

FIG. 1A illustrates a client-server based test and homework management system 100 according to the present invention. Client-server based system 100 comprises a server computer 101, a Local area network (LAN) or wide area network (WAN) or Internet 102, a plurality of network connections 103, and a plurality of client devices 104-106. The server computer 101 furnishes teacher T1 with all the tools necessary to create tests or homework questions and their corresponding answers. Students S1, S2 and S3 can download tests or homework assignments using client devices 104, 105, and 106, respectively. Client devices 104, 105, and 106 provide a computerized environment for students S1, S2, and S3 to work on their tests or homework assignments. Completed tests and homework answers are then uploaded to the server computer 101 for teacher T1 to grade. The corrected tests and homework answers are then available to be downloaded to the client devices 104, 105, and 106 for students S1, S2, and S3 to review. The server computer 101 provides a computerized tool for teacher T1 creating test and homework and grading tool for correcting completed test and homework. Note that in the embodiment described in FIG. 1A, teacher T1 works on server computer 101 directly. This design, however, can be extended to a distributed model, where a teacher can connect to a server remotely to perform test and homework creation and grading by using a client device. Network 102 provides connectivity via wired or wireless network connections 103 between server computer 101 and client devices 104, 105, and 106 for the downloading and uploading operations.

The method and system of present invention utilize general-purpose computing devices at both the server side and the client side. A general-purpose computing device 125 illustrated in FIG. 1B thus can be used as either a server computer or a client device. Computing device 125 comprises a processor 120, user interface peripherals 122 including monitor, keyboard, and mouse, a network input and output (I/O) module 123 for sending and receiving data from network, and a storage device 121 for storing data. The storage device 121 is a type of computer-readable medium (i.e. a type of memory such as RAM, ROM, CD, DISK, etc.) and further comprises software programs and databases that implement and facilitate the client-server based test and homework administration process. Software programs comprise instructions stored in a computer-readable medium 121, when executed by processor 120, causing processor 120 to perform desired functions. In one novel aspect, the client-server based test and homework management system 100 comprises both server side and client side programs and databases that enable the process of test and homework administration to be efficient, secure, and convenient. In one example, laptop computers are used by both teachers and students for the process of test and homework administration via the Internet.

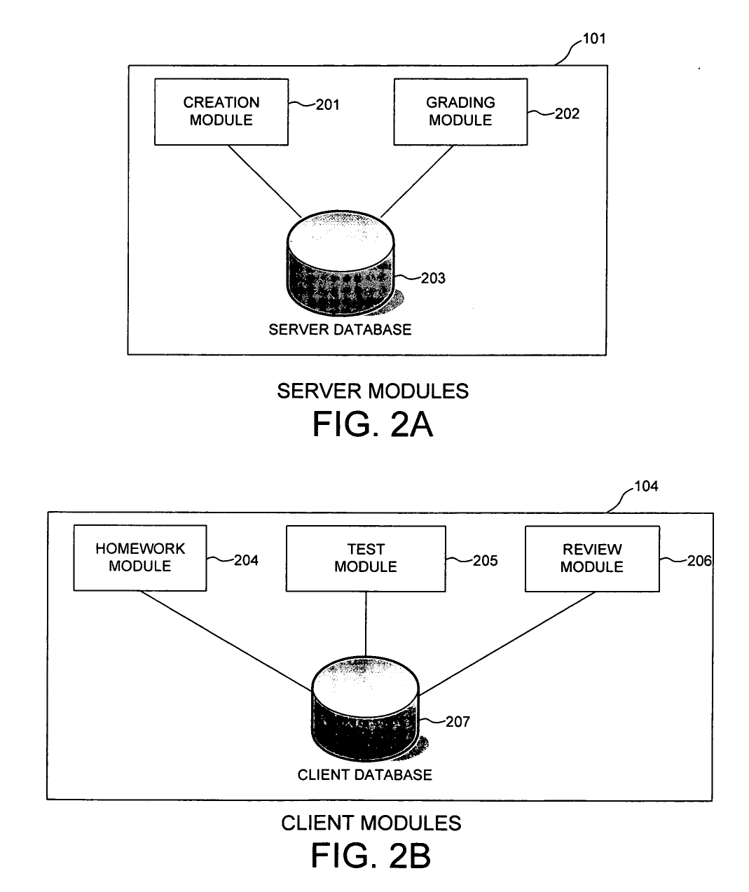

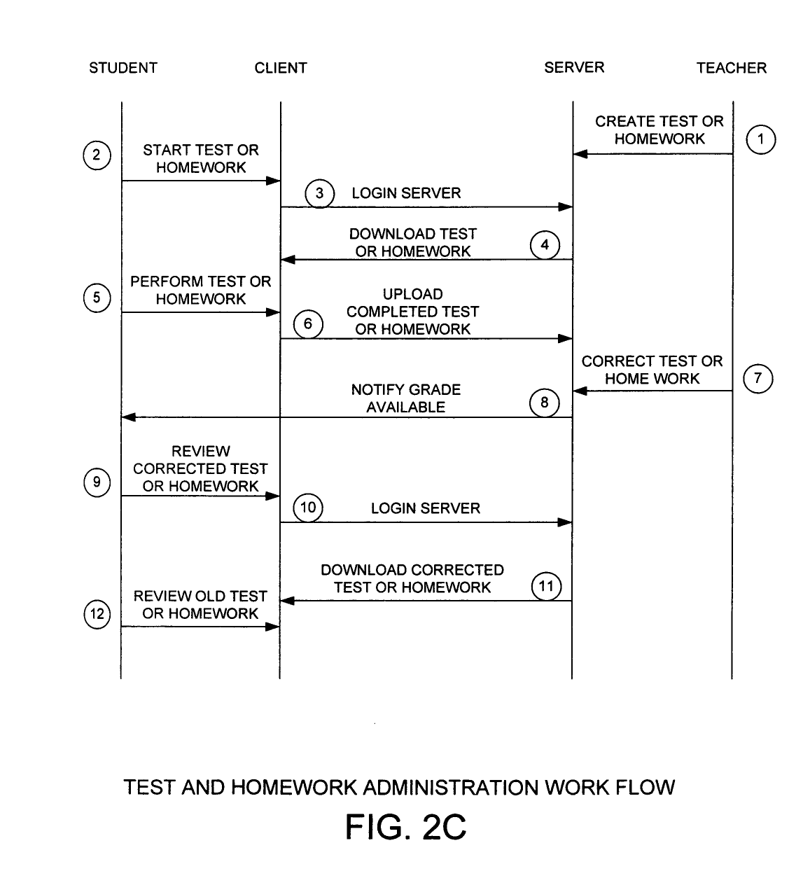

FIG. 2A shows the main software modules on server 101 in FIG. 1A. Server 101 comprises a creation module 201 running a creation program, a grading module 202 running a grading program, and a server database 203 that stores all the information needed for test and homework management. Information in server database 203 includes student profiles such as name, student number, class, and login credentials, as well as tests and homework questions and their corresponding answers. In one example, server database 203 is implemented using MySQL, which can be used in PHP and outputted in XML format for client parsing. Creation module 201 provides the teacher with all the tools required for creating a test or homework. For example, teacher T1 can select an existing question from server database 203 to be included in the test or homework. Alternatively, teacher T1 can create a new question to be part of the test or homework. The teacher uses grading module 202 to grade a student's completed test or homework. After the completed test and homework are uploaded from a client device to server 101, grading module 202 performs automatic grading on set-answers, multiple choices, and creative responses. Auto-grading saves teachers an unprecedented amount of time, leaving them free on the fundamental aspect of their job: teaching. In one example, the server programs are implemented as web applications using PHP.

FIG. 2B illustrates the main software modules on a client device, such as client device 104 in FIG. 1A. Client device 104 comprises a homework module 204 running a homework program, a test module 205 running a test program, a review module 206 running a review program, and a client database 207. Client database 207 contains tests and homework questions to be completed, as well as tests and homework assignments completed previously and graded by the teacher. In one example, client database 207 is implemented using SQLite and the XML language. Test module 205 administers the testing process for students to take a test in a secured way, while homework module 204 allows students to work on homework assignments without network connectivity. The previously completed tests and homework are saved in client database 207 and can be retrieved by review module 206 for students to review at anytime in the future. In one example, the client programs are implemented using Cocoa and the Objective-C language.

FIG. 2C is a high-level message sequence chart that illustrates the workflow in client-server based computer-aided test and homework management system 100. At step 1, a teacher (T1) uses a test and homework creation module 201 to create a test or homework assignment. A student (S1-S3) starts the test or assigned homework at step 2 by launching the client program. After logging in the server at step 3, client device (104-106) displays a list of test or homework titles that are applicable for that student (e.g. not a future test/assignment date), who can then download the test or homework that the student wants to take at step 4. Upon completing the test or homework at step 5, the student can upload the completed test or homework to server at step 6. The teacher then can use the grading module 202 on the server to start the grading process. A notification, such as email, text message, or notification inside of the client application, is sent to the student at step 8 after grading is completed at step 7. The student then can review the corrected test or homework by starting the client program (step 9), logging in to the server (step 10), and downloading the corrected test or homework at step 11. As the corrected test and homework are downloaded and saved in client database 207, the student can review all the tests and homework that were completed previously (step 12) at anytime whenever the student wants.

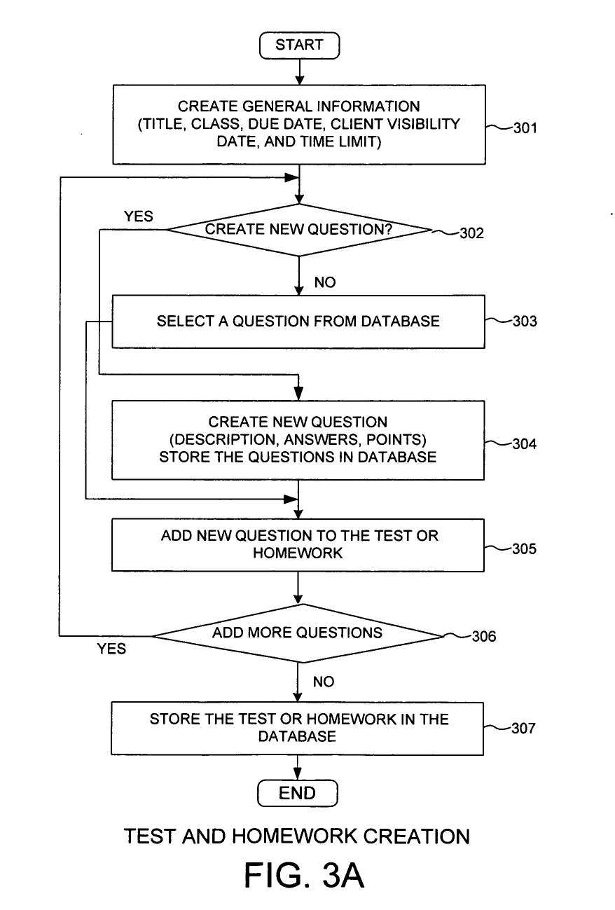

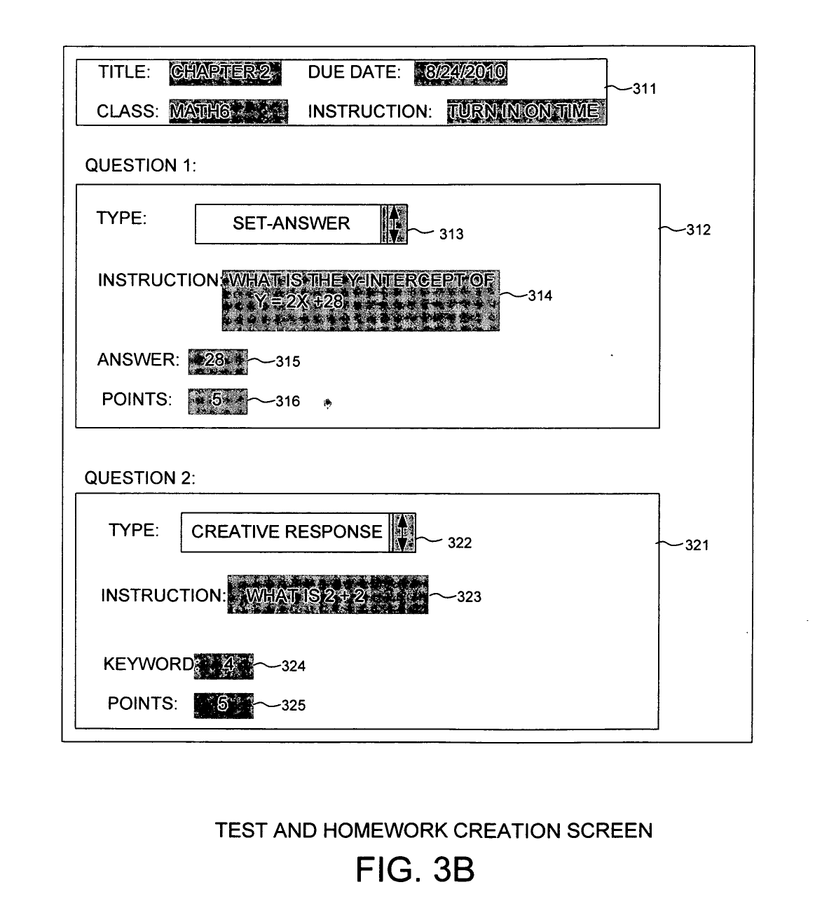

FIG. 3A describes more details of the test and homework creation program implemented in creation module 201 in FIG. 2A on the server side. After the teacher starts the creation program, block 301 allows the teacher to type in general information about the test or homework such as the title, display date, due date, class, and description. To add a question to the test or homework, the teacher has the choice of creating a new question in block 304 or reusing an existing question in the database as shown in block 303. When creating a new question, block 304 allows the teacher to specify the question type, instruction, correct answer, and points, as well as pre-defined keywords for questions requiring creative responses. The teacher can add as many questions as desired by repeating block 303, 304, and 305. After completing the test or homework creation process, block 307 allows the teacher to save the test or homework in server database 207 for students to download at an appropriate time.

FIG. 3B shows a screen mockup for homework or test creation. To start with, a teacher inputs general information about the homework or test, such as title, class, due date, and instructions, as shown in box 311. Box 312 illustrates how the teacher can create a question. First, the teacher chooses set-answer as the question type by using pull-down menu 313. Then the teacher inputs all data needed for creating a set-answer question, such as instruction in field 314, correct answer in field 315, and points in field 316. To create a question with creative response shown in box 321, the teacher specifies creative response as the question type by using pull-down menu 322, and inputs the instruction and points in field 323 and field 325 respectively. However, instead of specifying the exact correct answer for a set-answer question, the teacher inputs pre-defined keyword (4) in filed 324. Pre-defined keyword is used by grading module 202 in FIG. 2A for auto-grading a creative response. Note that the screen layout is dynamically adjusted to show all fields that are applicable for a question type once the question type is specified in the pull-down menu. In this example, once the teacher chooses set-answer as the question type in field 313, the answer field 315 appears to allow the teacher to input the correct answer. Similarly, once the teacher chooses creative response as the question type in field 322, the keyword field 324 appears to allow the teacher to input the pre-defined keyword.

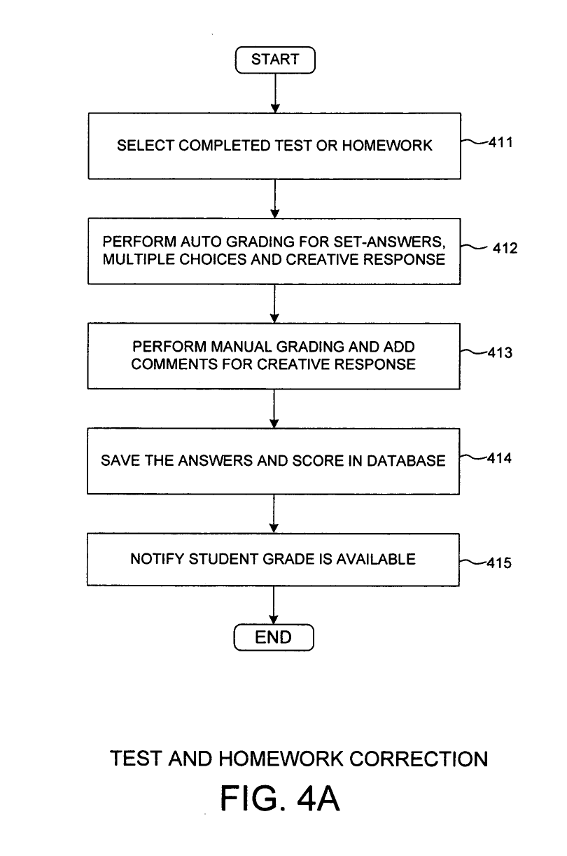

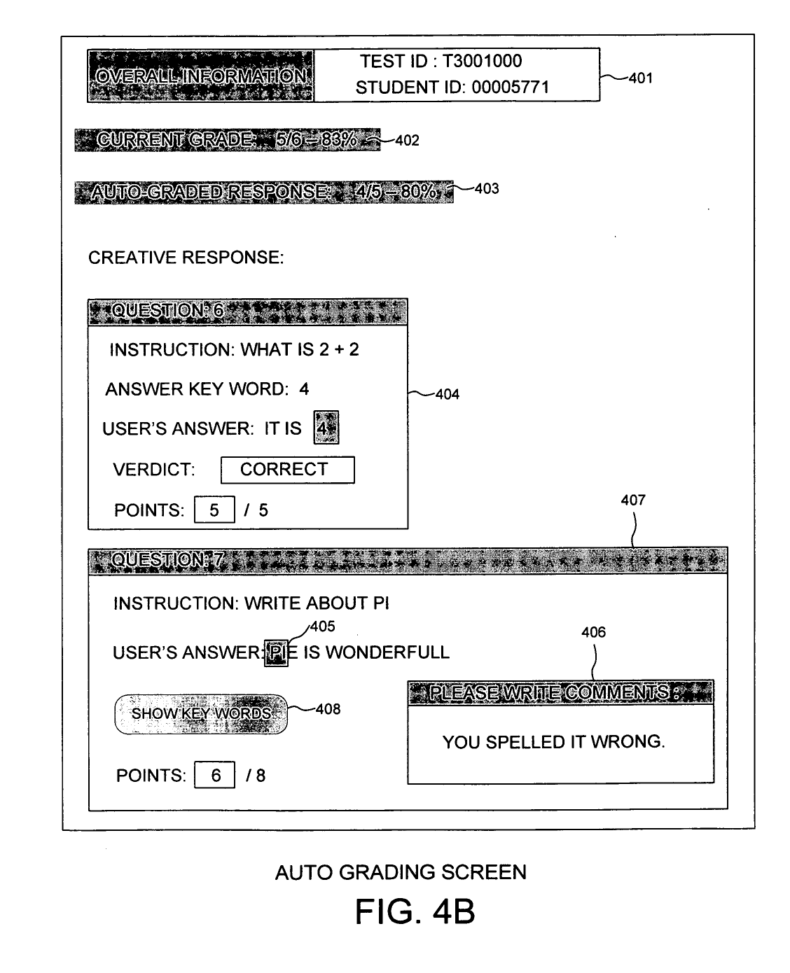

FIG. 4A illustrates the test and homework grading program provided by grading module 202 in FIG. 2A on the server side. The teacher starts the grading process by selecting a student's completed test or homework at block 411. Block 412 performs automatic grading on questions with set-answer, multiple choices, and creative response. Block 413 then allows the teacher to manually grade and comment on creative responses.

Referring now to FIG. 4B, a screen layout of the correction module 202. In this example, a created test consists of seven questions among which the first five questions have set-answers or multiple choices while question 6 and question 7 have creative responses. At the top of the screen, box 401 displays the general information, including the identity of the test and the student who submitted answers. The current grade, 5/6-83%, is shown in box 402. The value in box 402 is automatically adjusted as the grading process progresses, and the final score is shown when the entire grading process is completed. The auto-grading score, 4/5-80%, from auto-grading for the first five questions is shown in box 403. Box 404 illustrates one example of auto-grading for a creative response using keyword-matching method. In this example, “4” is stored in the database as a pre-defined keyword for question 6. Since keyword “4” is present in the student's response—“It is 4”, the response is automatically marked as correct. The teacher can overwrite the result of auto-grading on a creative response, as auto-grading for creative response may not be accurate in all cases. The teacher can also modify the grading for set-answer and multiple choice answers. Box 407 shows an example of grading creative response by highlighting pre-defined keywords. In this example, grading module 202 highlights all the pre-defined keywords present in the response for question 7. For instance, if “PI” is a pre-defined keyword that is stored in the database for question 7, then “PI” is highlighted in the response as shown in box 405 when the teacher clicks box 408 “show key words”. The highlighted keywords in the response would help the teacher to identify quickly how many keywords are present in the response and whether the student's response hits those key points. Highlighting keywords is especially useful for the teacher in grading lengthy responses. Furthermore, once the teacher selects the desired comment area in the response, box 406 provides the teacher the ability to insert comments in a context sensitive manner as part of the grading process.

Referring now back to FIG. 4A, after the teacher completes grading for all questions for a test or homework assignment, the corrected test or homework is saved in the server database at block 414. At block 415, an email, text message, or client application notification is sent to the student to notify the student that the corrected test and homework are available for downloading and reviewing.

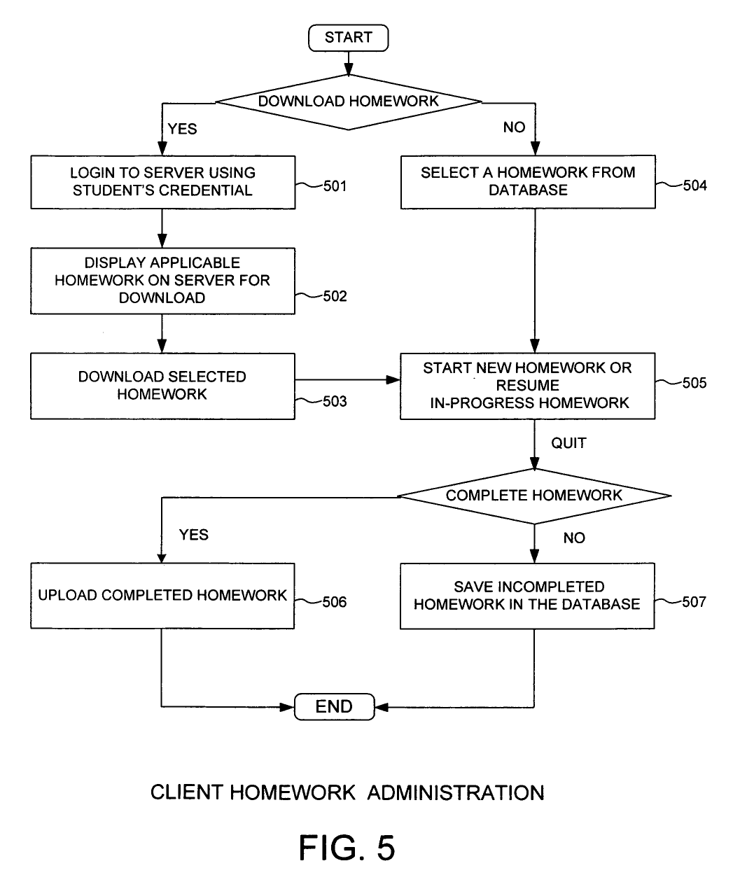

FIG. 5 illustrates the workflow of homework module 204 in FIG. 2B on the client side. After the homework program starts, a student can select a new homework or in-progress homework from the client database at block 504. Alternatively, the student can login to the server and download a homework assignment at block 501, 502, and 503. At block 505, the student works on questions in the homework, and the answers are saved in the client database. After all the questions in the homework assignment are completed, the completed homework can be uploaded to the server at block 506. At any time, the student can quit the homework program without completing the homework, and the status of the in-progress homework will be saved in the client database at block 507. The student can resume the in-progress homework later. Notice that since the new and in-progress homework are downloaded and saved in the client database, the student can work on the homework without the client device staying connected to the server. This greatly increases the flexibility of where the homework can be completed by the student. For example, the student may first download a new homework from the server, and later complete the homework at a place that internet service is not available.

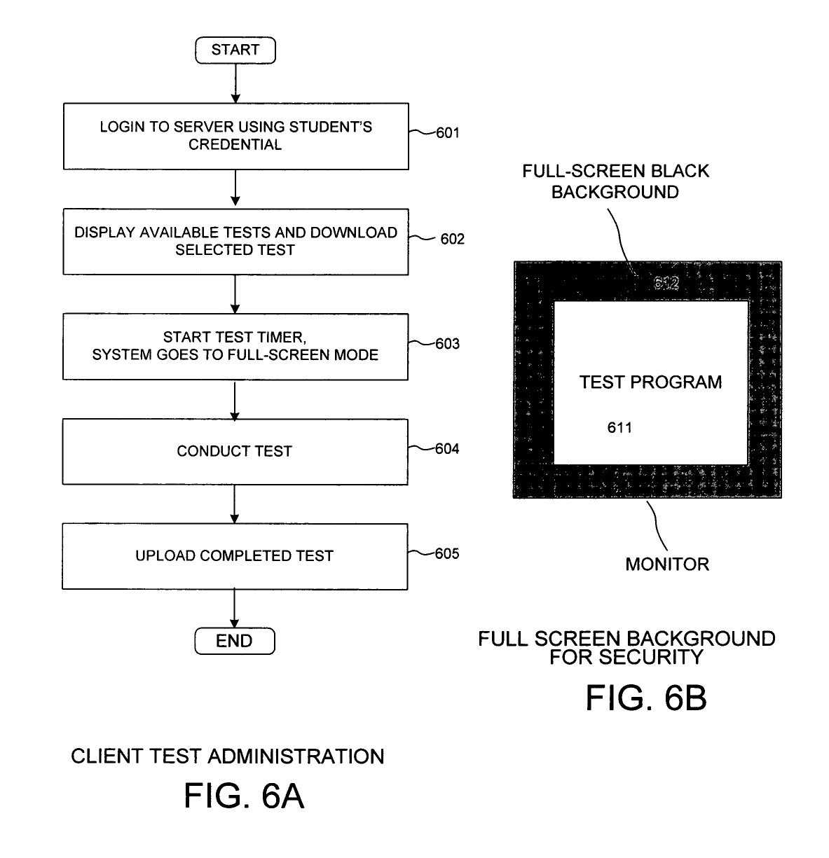

FIG. 6A is a flow chart for test module 205 in FIG. 2B on the client side. After logging-in to the server at block 601 and downloading the test at block 602, the test program switches to an environment clear of other applications that could serve as distractions or cheating utensils. Once the testing starts at block 603, student cannot exit out the test program or switch to other programs, as shown in FIG. 6B.

In the example of FIG. 6B, all areas behind the test program window 611 are occupied by a black background 612. As a result, all other programs and operation system services become un-accessible. Furthermore, the test program provides neither any button for minimizing the window nor any menu to quit the program. Therefore, the student can only follow the control flow by completing the questions one after another. The test program on the client device ends when all the questions in the test are completed at block 604 and the result is uploaded to the server at block 605. In the event of a student stopping the test program by turning off the client device, any intermediate result would be lost, and the test fails. Similar to the homework program, since the test questions are downloaded to the client devices at the beginning of the test, the network access at block 604 is not required. This is useful even if the testing is administered in a central location, since the testing can be conducted successfully in the event of a server or network failure. The completed test result can be uploaded to the server later, when the server and network connectivity are recovered from the failure.

In one or more exemplary embodiments, the functions described above may be implemented in hardware, software, firmware, or any combination thereof. If implemented in software, the functions may be stored on or transmitted over as one or more instructions or code on a computer-readable (processor-readable) medium. Computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that both can be used to carry or store desired program code in the form of instructions or data structures, and can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

What is claimed is:

1. A method for managing test and homework by a computer server, comprising:
generating a plurality of test or homework questions and transmitting the generated questions via a network to a client device, wherein the questions are generated by creating new questions or reusing existing questions in a data repository; and
automatically grading a completed test or homework in response to the plurality of questions, wherein the auto-grading involves matching pre-defined keywords in a narrative response.

2. The method of claim 1, wherein the auto-grading also involves highlighting pre-defined keywords in a narrative response.

3. The method of claim 1, further comprising:
sending out notifications via the network upon a corrected test or homework is available for review.

4. A computer-readable medium storing instructions that, when executed by a processor, cause the processor to perform a method, the method comprising:
generating a plurality of test or homework questions and transmitting the generated questions via a network to a client device, wherein the questions are generated by creating new questions or reusing existing questions in a data repository; and
automatically grading a completed test or homework in response to the plurality of questions, wherein the auto-grading involves matching pre-defined keywords in a narrative response.

5. The computer-readable medium of claim 4, wherein the auto-grading also involves highlighting pre-defined keywords in a narrative response.

6. The computer-readable medium of claim 4, further comprising:
sending out notifications via the network upon a corrected test or homework is available for review.

7. A server system for administering test and homework, comprising:
a data repository for storing a plurality of questions;
a creation module for creating a test or a homework assignment by adding a plurality of new questions, or by reusing existing questions stored in the server repository; and
a grading module for automatically grading answers of a completed test or homework assignment in response to the test or homework assignment.

8. The server system of claim 7, wherein the grading module automatically grades set-answers and multiple choices.

9. The server system of claim 7, wherein the grading module automatically grades a creative response by matching pre-defined keywords.

10. The server system of claim 7, wherein the grading module automatically highlights pre-defined keywords in a narrative response.

11. The server system of claim 7, wherein the grading module inserts a comment on the answer of a particular question.

12. The server system of claim 7, wherein the grading module sends out notifications upon a corrected test or homework assignment is available for review.

13. A method, comprising:
downloading a test or homework assignment comprising a plurality of questions to a computing device via a network;
administering a testing process in a secured way by displaying a full-screen black background to block access to all other programs running on the computing device, wherein the testing process cannot be exited until completion, and wherein the computing device is a general-purpose computing device running a generic operating system; and
uploading a completed test or homework assignment in response to the downloaded questions.

14. The method of claim 13, further comprising:
saving the homework assignment on a local database of the computing device, wherein the homework assignment is completed at a later time with or without network connectivity.

15. The method of claim 13, further comprising:
downloading a corrected test or homework assignment on a local database of the computing device, wherein the corrected test or homework assignment is reviewed at a later time.

16. A computer-readable medium storing instructions that, when executed by a processor, cause the processor to perform a method, the method comprising:
downloading a test or homework assignment comprising a plurality of questions to a computing device via a network;
administering a testing process in a secured way by displaying a full-screen black background to block access to all other programs running on the computing device, wherein the testing process cannot be exited until completion, and wherein the computing device is a general-purpose computing device running a generic operating system; and
uploading a completed test or homework assignment in response to the downloaded questions.

17. The computer-readable medium of claim 16, further comprising:
saving the homework assignment on a local database of the computing device, wherein the homework assignment is completed at a later time with or without network connectivity.

18. The computer-readable medium of claim 16, further comprising:
downloading a corrected test or homework assignment on a local database of the computing device, wherein the corrected test or homework assignment is reviewed at a later time.

19. A client device for administering test and homework, comprising:
a data repository for storing a plurality of questions downloaded from a server system via a network; and
a test module administering a testing by displaying full-screen background to block access to other programs installed on the client device.

20. The client device of claim 19, wherein the testing cannot be exited until completion, and wherein the client device is a general-purpose computing device running a generic operating system.

21. The client device of claim 19, further comprising:
a homework module that allows working on a previously downloaded homework assignment at a later time with or without network connectivity, wherein the homework assignment is saved in the data repository.

22. The client device of claim 19, further comprising:
a review module for reviewing a previously completed test or homework assignment, wherein a corrected test or homework assignment corresponds to the'completed test or homework assignment is saved in the data repository for review.
